(19) United States
(12) Patent Application Publication
(10) Pub. No.: US 2026/0001110 A1
(43) Pub. Date: Jan. 1, 2026

(54) Sludge treatment unit and sludge recycling device including the same

(71) Applicant: KUMKANG BIO CO., LTD., Incheon (KR)

(72) Inventor: Young Jin SIM, Incheon (KR)

(21) Appl. No.: 18/922,432

(22) Filed: Oct. 22, 2024

(30) Foreign Application Priority Data
Jun. 28, 2024 (KR) 10-2024-0085631

(51) Int. Cl. B09B 3/32; B01D 29/35; B01D 29/90; B09B 3/38; B09B 3/60; B09B 101/70; F26B 17/20

(52) U.S. Cl. CPC B09B 3/32; B01D 29/35; B01D 29/90; B09B 3/38; F26B 17/20; B09B 3/60; B09B 2101/70; F26B 2200/18

(57) ABSTRACT

A sludge treatment unit provided in a sludge cycling device for recycling sludge discharged from a food waste treatment device and configured to treat the sludge introduced from the food waste treatment device includes a housing having a plurality of perforations to discharge water from inside to outside thereof, a sludge input hole provided in the housing to pass through from the outside to the inside of the housing to receive the sludge, a dehydrated sludge outlet provided at a side different from the sludge input hole to discharge dehydrated sludge, and a shaft having a shaft body portion provided inside the housing and a spiral blade provided on an outer circumferential surface of the shaft body portion, the shaft being rotated by a rotational force received from a motor to move the sludge from the sludge input hole toward the dehydrated sludge outlet.

### CROSS-REFERENCE TO RELATED APPLICATION

This application claims priority from and the benefit of Korean Patent Application No. 10-2024-0085631, filed on Jun. 28, 2024, which is hereby incorporated by reference for all purposes as if fully set forth herein.

### BACKGROUND

### Field

Embodiments of the invention relate generally to a sludge treatment unit and a sludge recycling device including the same.

### Discussion of the Background

As interest in reducing environmental pollutants gradually increases, methods of treating waste such as food waste are being improved. Research is being conducted on composting as one method of treating food waste. Only a very small portion of food waste generated in Korea is recycled as livestock feed or compost, and most food waste is disposed of through landfills. Such landfills not only cause environmental pollution due to problems such as leachate, but also have a negative impact on human health due to bad odors, pathogens, etc. and may cause serious problems such as contaminating water sources.

To solve the above problems, food waste reducing devices are being used as food waste treatment devices, and various methods such as drying, fermentation, fermentation drying, carbonization drying, composting, microbial liquid fermentation (microbial fermentation), and dehydration are being applied as reducing methods of these reducing devices. However, even when these treatment devices are used, there may be problems in that the sludge discharged after treatment has a high salt content, making it difficult to use as livestock feed, and the moisture content may be too high or too low to be used as compost. For example, even when food waste is treated by microbial liquid fermentation, the sludge (solid matter) discharged as a result of the treatment may still not be used as compost or feed due to a high salt content or the like and is discarded as waste.

Meanwhile, as an example of using food waste, a sludge recycling device proposed by the applicant of the present invention as shown in FIG. 1 may be cited. However, in this case, there may be a problem that the sludge drying efficiency is somewhat reduced because the sludge treated in a sludge treatment unit contains a large amount of water in a process of being discharged to a second sludge treatment unit.

The above information disclosed in this Background section is only for understanding of the background of the inventive concepts, and, therefore, it may contain information that does not constitute prior art.

### SUMMARY

The present invention is directed to improving a structure of a sludge recycling device in order to reduce the salinity of sludge discharged from a food waste treatment device and maintain the moisture content within an appropriate range to increase usability as compost or feed.

In addition, the present invention is directed to providing a sludge treatment device capable of preventing water from being discharged together with sludge in a sludge treatment process to the next process.

In addition, the present invention is directed to providing a means for improving the movement of sludge and increasing drainage capacity by increasing the directionality of a screw upon rotation.

In addition, the present invention is directed to providing a means for shortening a manufacturing process and reducing manufacturing costs and providing a means for causing the death of microorganisms in sludge and drying of sludge.

A sludge treatment unit provided in a sludge cycling device for recycling sludge discharged from a food waste treatment device and configured to treat the sludge introduced from the food waste treatment device according to the present invention includes a housing having a plurality of perforations to discharge water from inside to the outside thereof, a sludge input hole provided in the housing to pass through from the outside to the inside of the housing to receive the sludge, a dehydrated sludge outlet provided at a side different from the sludge input hole to discharge dehydrated sludge, and a shaft having a shaft body portion provided inside the housing and a spiral blade provided on an outer circumferential surface of the shaft body portion, the shaft beingrotated by a rotational force received from a motor to move the sludge from the sludge input hole toward the dehydrated sludge outlet.

Each of the plurality of the perforations may be formed as a straight perforation with a rectangular shape.

A longitudinal direction of the perforation may be formed and arranged parallel to a longitudinal direction of the housing.

The housing may have a non-perforation region in which the plurality of perforations are not formed within a predetermined length from an end portion thereof at which the dehydrated sludge outlet is located.

A tube-shaped sludge inlet may be connected to the sludge input hole.

The shaft body portion may be formed to have a diameter that increases from the sludge input hole toward the dehydrated sludge outlet.

Longitudinal directions of the plurality of perforations may be formed and arranged to be diagonal based on vertical and horizontal directions.

The dehydrated sludge outlet may be formed to be inclined upward toward an end portion thereof.

An overflow hole may be formed in an upper portion of the hosing to allow water to overflow from the inside of the housing.

It is to be understood that both the foregoing general description and the following detailed description are illustrative and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the inventive concepts.

FIG. 1 is a view for describing a method of treating sludge discharged from a food waste treatment device (food waste treatment machine), which is performed by a sludge recycling device, according to the present invention.

FIG. 2 is a block diagram for describing elements constituting the sludge recycling device according to the present invention.

FIG. 3 is a schematic diagram for conceptually describing the sludge recycling device according to the present invention.

FIG. 4 is a schematic diagram for describing structures and operation methods of a first control unit and a second control unit for composition input according to one embodiment of the present invention.

FIG. 5 shows a schematic perspective view (see FIG. 5A) and a side view (see FIG. 5B) of the sludge recycling device according to the present invention.

FIG. 6 is a schematic diagram for describing a structure and operation method of a second sludge treatment unit according to the present invention.

FIG. 7 is a schematic diagram for describing a structure of a plurality of stirring blades according to the present invention.

FIG. 8 is a view for describing a structure and operation method of a power transmission unit according to the present invention.

FIGS. 9 and 10 are views for describing a structure in which an air injection fan is installed in the sludge recycling device according to the present invention.

FIGS. 11 and 12 are a perspective view and a front view showing the exterior of a sludge treatment unit according to one embodiment.

FIGS. 13 and 14 are a front view and a plan view showing the exterior of the sludge treatment unit of FIG. 11 from which a perforated mesh case is removed.

FIG. 15 is a cross-sectional view showing the exterior of the sludge treatment unit of FIG. 12.

FIG. 16 is an unfolded view showing the unfolded exterior of the perforated mesh case according to another embodiment.

FIG. 17 is a front view showing the exterior of a sludge treatment unit adopting the perforated mesh case of FIG. 16.

FIGS. 18 and 19 are front views showing a sludge treatment unit according to other embodiments.

FIG. 20 is a plan view showing the sludge treatment unit of FIG. 19.

FIG. 21 is an exploded view showing the sludge treatment unit of FIG. 19.

### DETAILED DESCRIPTION

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z-axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of idealized embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the inventive concepts. Further, the blocks, units, and/or modules of some embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

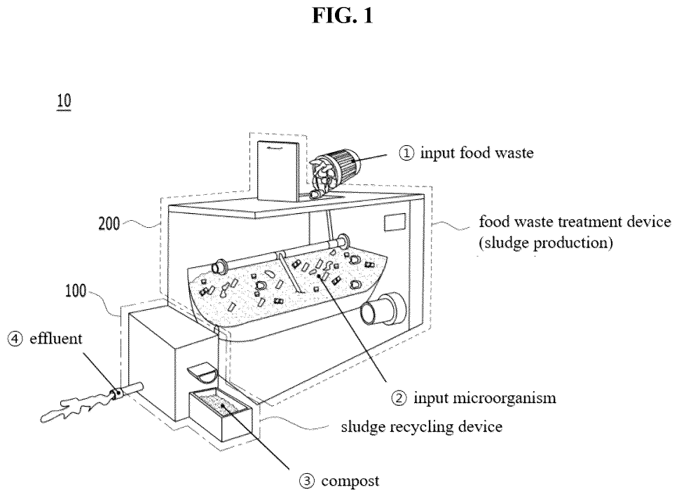

Referring to FIG. 1, a sludge recycling device according to one embodiment will be described. FIG. 1 is a view for describing a method of treating sludge discharged from a food waste treatment device, which is performed by a sludge recycling device, according to the present invention.

As shown in FIG. 1, a sludge recycling system 10 may include a food waste treatment device 200 (food waste treatment machine) and a sludge recycling device 100.

In the sludge recycling system 10, sludge discharged by the food waste treatment device 200 may be recycled as compost or feed through the sludge recycling device 100. Since the sludge discharged from the food waste treatment device 200 has a high salt content and inappropriate moisture content, it is difficult for the sludge to be used as compost or feed, but when the sludge passes through the sludge recycling device 100, dehydration or desalination treatment may be performed so that the sludge is able to be recycled.

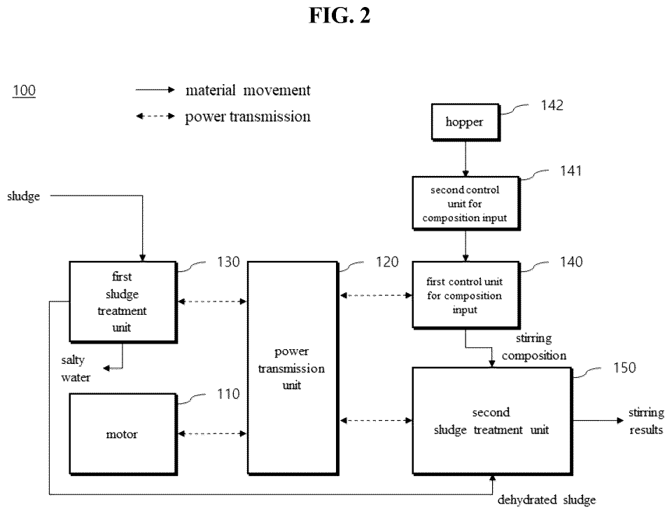

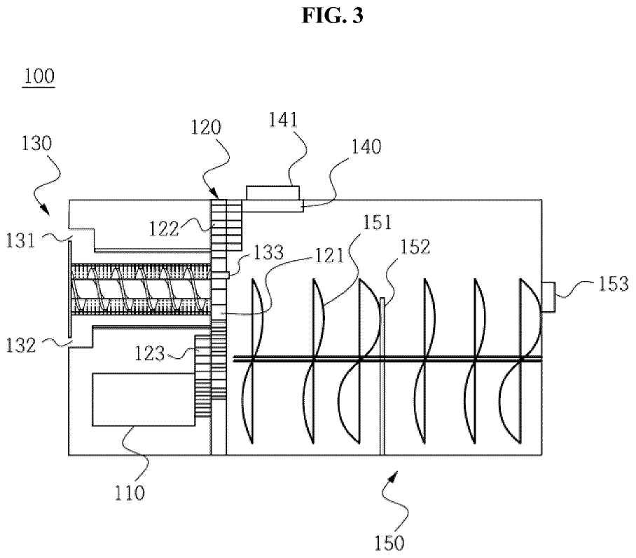

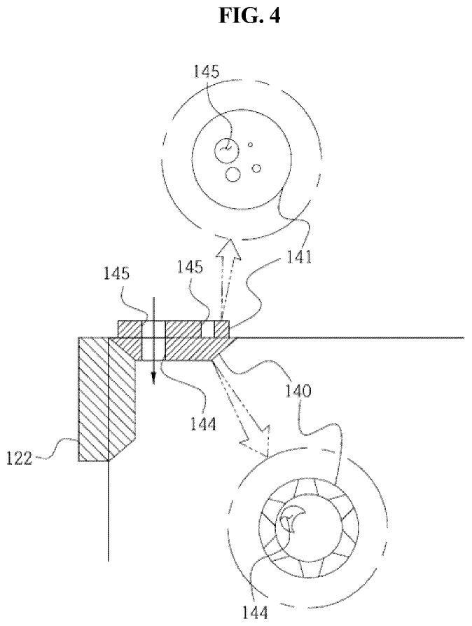

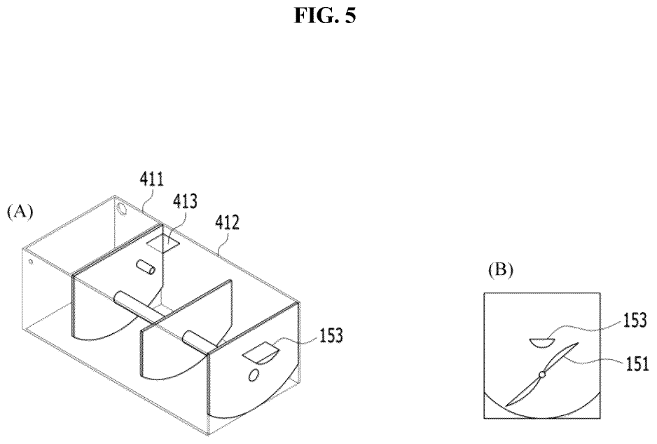

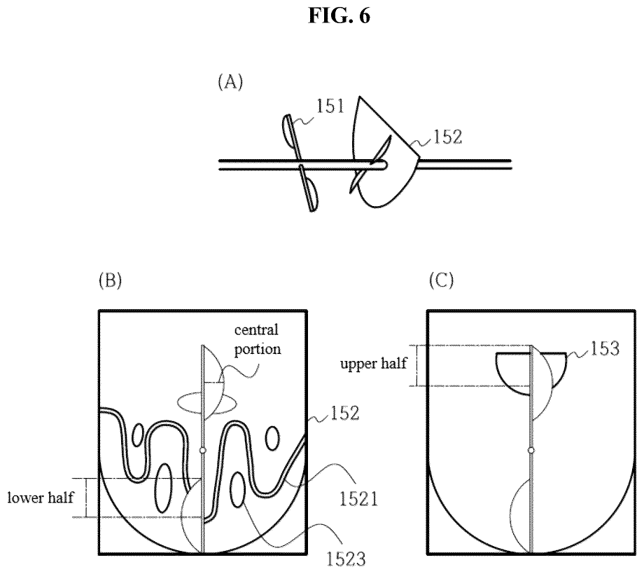

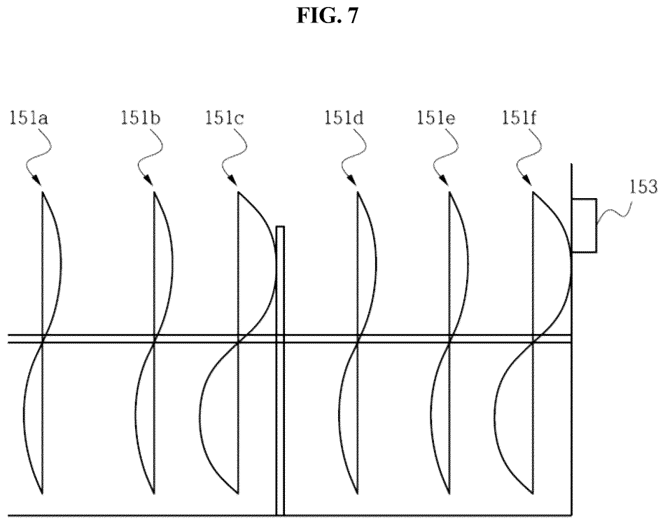

The sludge recycling device according to one embodiment will be described with reference to FIGS. 2 to 7. FIG. 2 is a block diagram for describing elements constituting the sludge recycling device according to the present invention, FIG. 3 is a schematic diagram for conceptually describing the sludge recycling device according to the present invention, and FIG. 4 is a schematic diagram for describing structures and operation methods of a first control unit and a second control unit for composition input according to one embodiment of the present invention. In addition, FIG. 5 shows a schematic perspective view (see FIG. 5A) and a side view (see FIG. 5B) of the sludge recycling device according to the present invention, FIG. 6 is a schematic diagram for describing a structure and operation method of a second sludge treatment unit according to the present invention, and FIG. 7 is a schematic diagram for describing a structure of a plurality of stirring blades according to the present invention.

First, describing the sludge recycling device 100 with reference to FIGS. 2 and 3, the sludge recycling device 100 may include a motor 110, a power transmission unit 120, a sludge treatment unit 130, and a second sludge treatment unit 150. However, the present invention is not limited thereto, and other components may be further included in the sludge recycling device 100. For example, as shown in FIG. 2, as another component, a first control unit 140 for composition input may be additionally included, and when the first control unit 140 for composition input is included, a second control unit 141 for composition input or a hopper 142 may be additionally included. In this case, the second control unit 141 for composition input may be provided on a lower end of the hopper 142.

In the sludge recycling device 100, a rotational driving force for driving the sludge treatment unit 130, the first control unit 140 for composition input, and the second sludge treatment unit 150 may be provided by the motor 110. The rotational driving force of the motor 110 may be transmitted through the power transmission unit 120.

The sludge recycling device 100 may perform dehydration treatment through the sludge treatment unit 130, and then generate and discharge stirring results after mixing the dehydrated sludge with a stirring composition through the second sludge treatment unit 150. In this case, the stirring composition may include rice husk and coffee grounds, and the stirring results may be used as compost or feed.

In the sludge recycling device 100, the stirring composition may be input into a stirring chamber of the second sludge treatment unit 150 through the hopper 142 and the first control unit 140 for composition input, and when the second control unit 141 for composition input is included, the stirring composition may be input into the stirring chamber of the second sludge treatment unit 150 through the hopper 142, the second control unit 141 for composition input, and the first control unit 140 for composition input. Meanwhile, an air injection fan may be installed in the stirring chamber to inject outside air into the stirring chamber to reduce the moisture content of the stirring results or microorganisms may be additionally input for fermentation and composting of the stirred mixture.

In the sludge recycling device 100, the sludge treatment unit 130 and the second sludge treatment unit 150 may be rotated only by the driving force of the motor 110, and when the first control unit 140 for composition input is additionally configured, the sludge treatment unit 130, the first control unit 140 for composition input, and the second sludge treatment unit 150 may be rotated. That is, the rotation of the sludge treatment unit 130, the rotation of the first control unit 140 for composition input, and the rotation of the second sludge treatment unit 150 may all be performed by the rotational driving force generated from the motor 110. The driving force of the motor 110 may be transmitted by the power transmission unit 120, and a gear or a belt may be used as a power transmission means. The power transmission unit 120 may be formed in various ways according to the arrangement structure of the sludge treatment unit 130 and the second sludge treatment unit 150, and there are no limitations on the number of gears and the type of power transmission means.

As an example, the power transmission unit 120 may include a first gear 121, a second gear 122, and a third gear 123 through which the rotational driving force generated from the motor 110 is transmitted. The first gear 121 may rotate the sludge treatment unit 130, the second gear 122 may rotate the first control unit 140 for composition input, and the third gear 123 may rotate the second sludge treatment unit 150, but the number of gears and the type of power transmission means may be changed and there are no limitations.

The sludge treatment unit 130 may include a sludge inlet 131 for receiving sludge from the food waste treatment device, a dehydration outlet 132 for discharging water dehydrated from sludge or water introduced from the food waste treatment device by the rotational driving force transmitted through the first gear 121, and a dehydrated sludge outlet 133 for discharging dehydrated sludge. Here, dehydration means reducing the moisture content of sludge, and desalination of sludge may also occur simultaneously during dehydration treatment. FIG. 3 is for describing the concept of the sludge treatment unit 130, and the specific configuration and structure of the sludge treatment unit 130 according to one embodiment of the present invention will be described below.

Referring to FIG. 4, the first control unit 140 for composition input may include an input hole 144 formed to be spaced apart from the center of rotation. The first control unit 140 for composition input may be, for example, rotated by a rotational driving force transmitted through the second gear 122 so that the stirring composition transmitted through the hopper 142 for composition input or the second control unit 141 for composition input may be input into the stirring chamber through the periodic rotation opening and closing of the input hole.

The second gear 122 may be composed of a left gear and a right gear that are divided by a partition wall, and these two gears may be in contact with the partition wall and rotate about one rotational axis. The right gear of the second gear 122 and the first control unit 140 for composition input may each be a gear in the form of a cogwheel so that the vertical rotational motion of the second gear 122 may become the horizontal rotational motion of the first control unit 140 for composition input. That is, the second gear 122 and the first control unit 140 may be mechanically connected in a bevel gear type and operated, and in addition, may be connected in any power transmission manner.

The second control unit 141 for composition input is installed at the lower end of the hopper 142 and may include one or more holes 145 with different diameters, and any one hole diameter may be manually selected to control the amount of input stirring composition. The holes 145 (second control unit holes) formed in the second control unit 141 for composition input have different diameters to control the amount of input stirring composition, and any one hole diameter may be manually selected.

Meanwhile, the input hole 144 formed in the first control unit 140 for composition input may have a shape that is the same as or different from the second control unit hole 145 and when formed in the same shape, may have the same size as a hole with the largest diameter among the second control unit holes 145.

The stirring composition may be loaded into the hopper 142 (see FIG. 2) for composition input and moved toward the stirring chamber through the second control unit hole 145 with one selected diameter. The stirring composition passing through the second control unit hole 145 may additionally pass through the input hole 144 formed in the first control unit 140 for composition input and may be input into the stirring chamber side.

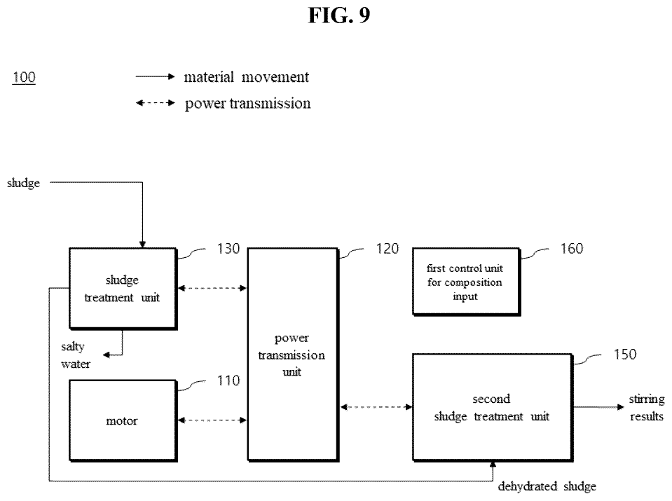

The second sludge treatment unit 150 may include a plurality of stirring blades 151 for stirring the dehydrated sludge or the dehydrated sludge and stirring composition by being rotated by the rotational driving force transmitted through the third gear 123 in the stirring chamber, a partition wall 152 for partitioning the stirring chamber, and a stirring results outlet 153 for discharging stirring results. In another configuration, an air injection fan may be additionally installed in the stirring chamber of the second sludge treatment unit 150 to lower the moisture content of the stirring results. This will be further described in FIG. 9.

The dehydrated sludge input by the sludge treatment unit 130 and the stirring composition input through the first control unit 140 for composition input may be stirred by the plurality of stirring blades 151 in the stirring chamber of the second sludge treatment unit 150 and discharged to the outside of the sludge recycling device 100 through the partition wall 152 and the stirring results outlet 153.

Meanwhile, as shown in FIG. 5, the sludge recycling device 100 may be separated into a left portion 411 and a right portion 412 by a separation wall and separated into a stirring chamber exterior and a stirring chamber interior based on a composition inlet 413. The left portion 411 may be provided with the motor 110 and the sludge treatment unit 130, and the right portion 412 may be provided with the first control unit 140 for composition input and the second sludge treatment unit 150. In addition, a hopper (not shown) may be provided above the composition inlet 413, and the second control unit 141 for composition input having one or more holes with different diameters as described above may be additionally provided at the lower end of the hopper. In addition, the first control unit 140 for composition input and the second sludge treatment unit 150 may be provided under the composition inlet 413. As shown in FIG. 5B, a lower portion of the stirring chamber of the second sludge treatment unit 150 may be formed in a circular shape to reflect the rotation of the stirring blade 151.

Referring to FIG. 6, specific structures A, B, and C in which the plurality of stirring blades 151, the partition wall 152, and a stirring results outlet 153 that constitute the second sludge treatment unit 150 are formed may be exemplarily shown.

As shown in FIG. 6A, the plurality of stirring blades 151 may be formed on one shaft, and the shaft may receive the rotational driving force of the motor 110 through the third gear 123. The shaft may pass through the partition wall 152, and the plurality of stirring blades 151 may be formed on both left and right sides of the partition wall 152.

In addition, as shown in FIG. 6B, the partition wall 152 may include a heating line pattern 1521. Specifically, the partition wall 152 may include the heating line pattern 1521 for adjusting a temperature of a mixture of the desalinized sludge and stirring composition being stirred, and the heating line pattern 1521 may be provided in a space between the left and right sides of the partition wall 152 in an aluminum tube internal insertion manner. Since the temperature of the mixture of the desalinated sludge and the stirring composition may be maintained within a desired range through the heating line pattern 1521 formed on the partition wall 152, microbial fermentation/composition can be performed more efficiently.

In addition, as shown in FIG. 6B, the partition wall 152 may include a plurality of partition wall holes 1523. Specifically, the partition wall 152 may include the plurality of partition wall holes 1523 through which the mixture is moved beyond the partition wall, and the plurality of partition wall holes 1523 may be positioned on a path along which a lower half of each stirring blade 151 passes, and the partition wall 152 may be formed to have the same height as the maximum height that allows a central portion of each stirring blade 151 to pass.

Since center positions of the plurality of partition holes may be located on the path along which the lower half of the stirring blade 151 passes, the mixture may more effectively pass through the plurality of partition wall holes and move to the opposite side by the stirring blade 151. In addition, when a height of the partition wall 152 is formed to be the same as the maximum height that allows the central portion of the stirring blade 151 to pass, the mixture may be smoothly stirred while efficiently passing through the partition wall 152.

Meanwhile, as shown in FIG. 6C, a position at which the stirring results outlet 153 is formed may also be determined in consideration of the path along which the stirring blade 151 passes. That is, when the stirring results outlet 153 is formed at a position corresponding to an upper half of the stirring blade 151, the efficiency of discharging the stirring results through the stirring results outlet 153 can be increased.

Referring to FIG. 7, the plurality of stirring blades 151 may include a first stirring blade 151a to a sixth stirring blade 151f. The first stirring blade 151a to the third stirring blade 151c may be positioned on an input side on the left side of the partition wall 152, and the fourth stirring blade 151d to the sixth stirring blade 151f may be positioned on a discharge side on the right side of the partition wall 152.

Since the third stirring blade 151c and the sixth stirring blade 151f are respectively positioned adjacent to the partition wall 152 and the stirring results outlet 153, the third stirring blade 151c and the sixth stirring blade 151f may each be formed in a different shape from the remaining stirring blades 151a, 151b, 151d, and 151e. That is, the plurality of stirring blades 151 may include first to third stirring blades 151a, 151b, and 151c formed on an input side of the stirring chamber partitioned by the partition wall 152 and the fourth to sixth stirring blades 151d, 151e, and 151f formed on a discharge side of the stirring chamber partitioned by the partition wall 152, and the third stirring blade 151c on the input side disposed adjacent to the partition wall 152 and the sixth stirring blade 151f on the discharge side disposed adjacent to the stirring results outlet 153 may have curvatures larger than those of the remaining stirring blades 151a, 151b, 151d, and 151e.

In this way, as the curvatures of the third stirring blade 151c and the sixth stirring blade 151f are set to be larger to have a more concavely and deeply recessed structure, a process of moving the mixture of desalinized sludge and stirring composition beyond the partition wall 152 and discharging the stirring results through the stirring results outlet 153 may be performed more smoothly.

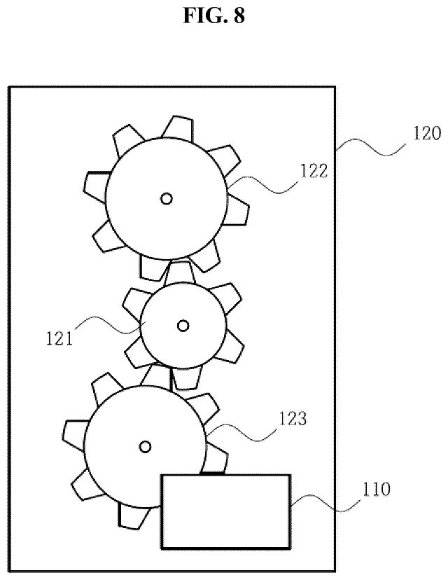

As shown in FIG. 8, the rotational driving force generated from the motor 110 may be transmitted to one or more engaged gears of the power transmission unit 120. As an example, the rotational driving force generated from the motor 110 may be transmitted to the engaged first gear 121 and third gear 123 of the power transmission unit 120, and when the first control unit 140 for composition input is included as a component, the rotational driving force generated from the motor 110 may be transmitted to the engaged first gear 121, second gear 122, and third gear 123 of the power transmission unit 120. In this case, the first gear 121 and the second gear 122 are rotated at different rotational speeds by the same rotational driving force so that the desalinized sludge and the composition may be mixed at the same mixing ratio. In addition, the size of the hole of the second control unit 141 for composition input may be selectively applied differently to control the mixing amount.

However, such a structure is only one embodiment and may be implemented in any power transmission structure depending on the arrangement and directions of other components, and there are no special limitations thereon.

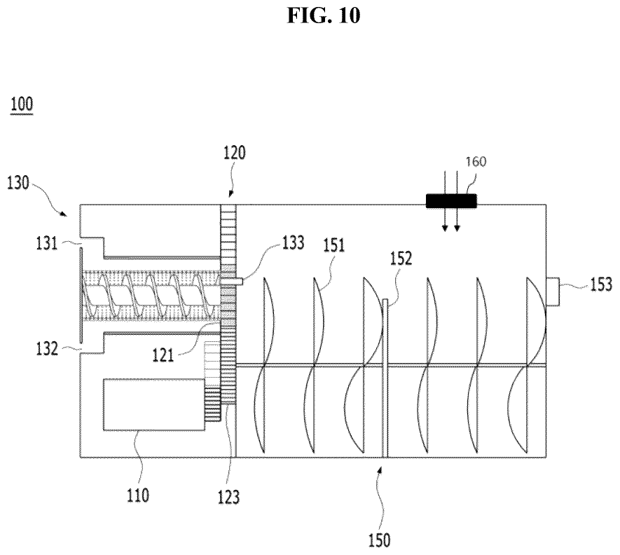

A sludge recycling device according to another embodiment will be described with reference to FIGS. 9 and 10. FIGS. 9 and 10 are views for describing a structure in which an air injection fan is installed in the sludge recycling device according to the present invention. The air injection fan may be installed instead of the first control unit for composition input or additionally installed together with the first control unit for composition input.

Referring to FIGS. 9 and 10, the sludge recycling device 100 may further include an air injection fan 160. Compared to the sludge recycling device 100 described above with reference to FIGS. 1 to 8, the sludge recycling device 100 may have the air injection fan 160 instead of the second gear 122, the first control unit 140 for composition input, the second control unit 141 for composition input, and the hopper 142. Alternatively, the sludge recycling device 100 may have the air injection fan 160 in addition to the second gear 122, the first control unit 140 for composition input, the second control unit 141 for composition input, and the hopper 142.

The air injection fan 160 may be for injecting outside air to dry the stirring results discharged through the stirring results outlet 153. Here, drying means reducing the moisture content of the stirring results, but does not mean a state in which the moisture content is zero. Therefore, processing the moisture content of the stirring results to 40% or less may also correspond to drying. The air injection fan 160 may form an air flow between the stirring chamber and the outside, thereby drying (reducing the moisture content) the stirring results that are present inside the stirring chamber.

Meanwhile, the sludge recycling device 100 may additionally include an air exhaust fan (not shown) in addition to the air injection fan 160.

The air exhaust fan may be for exhausting air to the outside of the stirring chamber so that the moisture content of the stirring results discharged through the stirring results outlet 153 is 40% or less. For example, the inside of the stirring chamber may have a slightly high temperature due to the fermentation process and the heating line, and the air injection fan 160 and the air exhaust fan may operate in opposite directions to circulate air in such a high temperature and humidity environment to lower the moisture content.

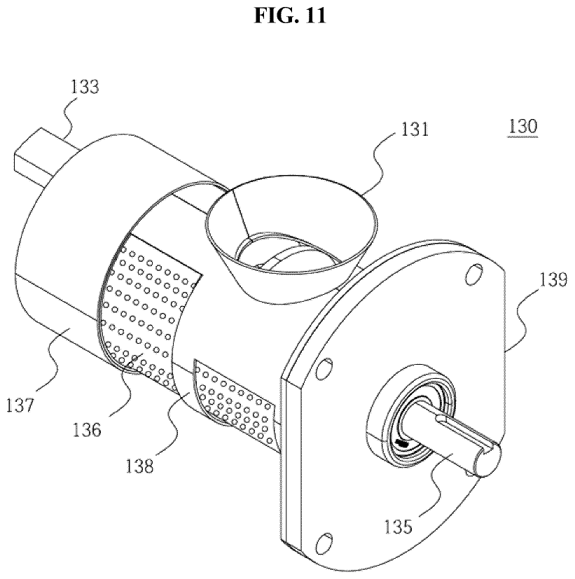

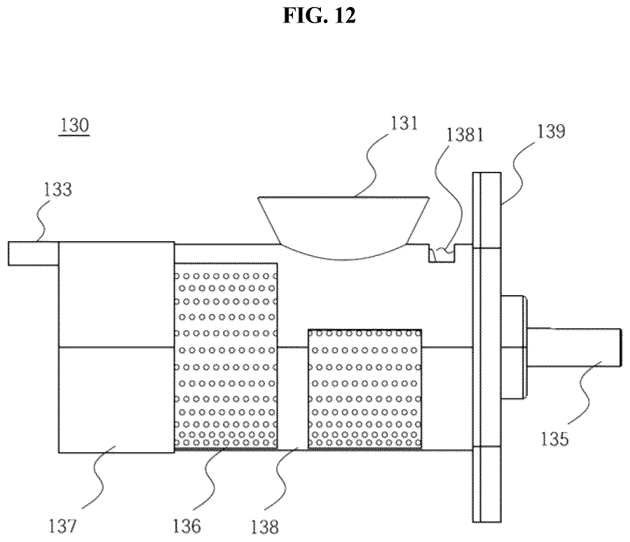

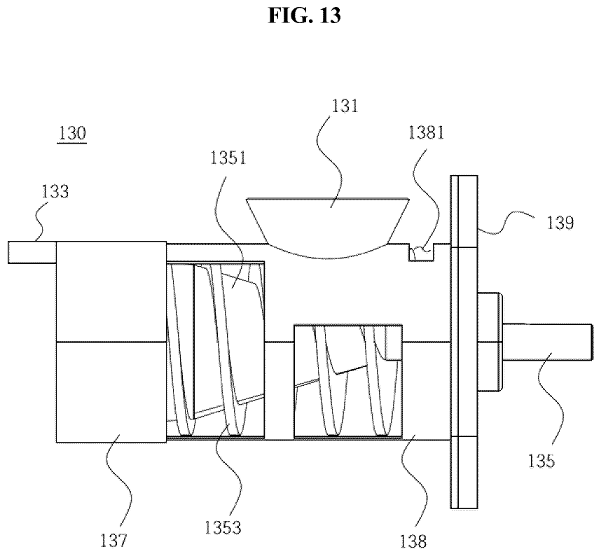

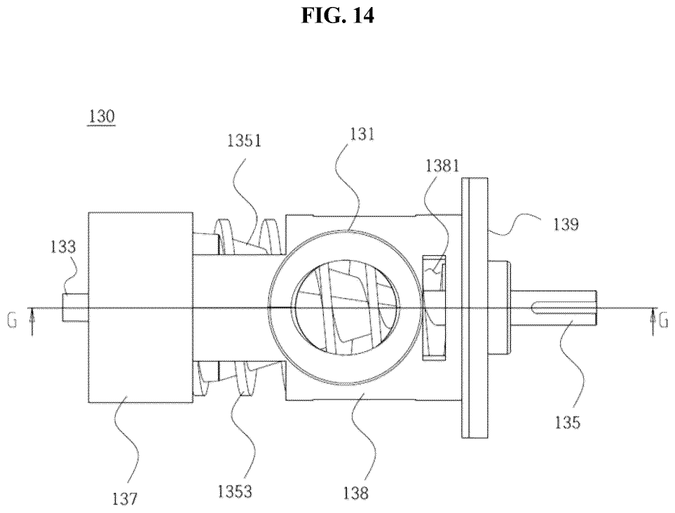

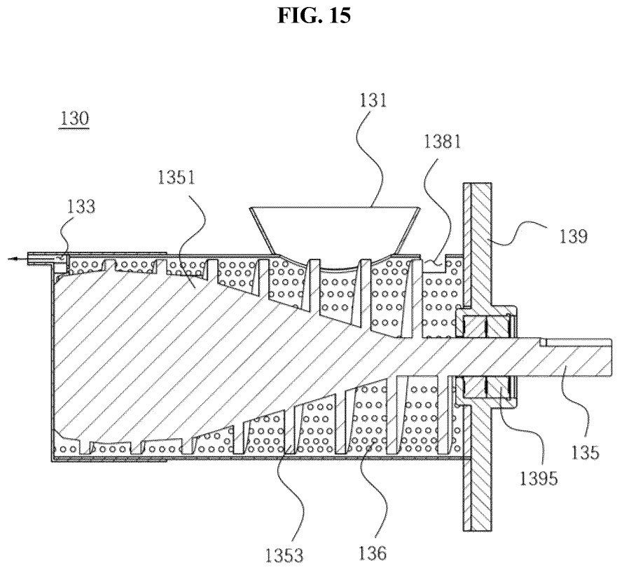

The sludge treatment unit 130 according to one embodiment will be described with reference to FIGS. 11 to 15. FIGS. 11 and 12 are a perspective view and a front view showing the exterior of a sludge treatment unit according to one embodiment, FIGS. 13 and 14 are a front view and a plan view showing the exterior of the sludge treatment unit of FIG. 11 from which a perforated mesh case is removed, and FIG. 15 is a cross-sectional view showing the exterior of the sludge treatment unit of FIG. 12.

The sludge treatment unit 130 includes housings 137, 138, and 136, a shaft 135, a support 139, and the sludge inlet 131.

The housing includes a sludge treatment unit first case 137, a sludge treatment unit second case 138, and a perforated mesh case 136. The housing forms the exterior of the sludge treatment unit 130 and forms a constant space therein. Since the sludge treatment unit first case 137, the sludge treatment unit second case 138, and the perforated mesh case 136 may be formed in various ways depending on manufacturing convenience and selection in a design stage and may also be formed integrally, it does not mean that the above components should be physically separated. That is, the perforated mesh case 136 may be implemented by perforating portions of the sludge treatment unit first case 137 and the sludge treatment unit second case 138.

The sludge inlet 131 is provided on an upper portion of the sludge treatment unit second case 138, and sludge or diluted water introduced from the food waste treatment device through the sludge inlet 131 flows into an inner space formed by the sludge treatment unit first case 137, the sludge treatment unit second case 138, and the perforated mesh case 136.

An overflow hole 1381 is formed in the upper portion of the sludge treatment unit second case 138 as shown in FIGS. 13 and 14. Water derived from the diluted water and sludge that flow therein is allowed to overflow through the overflow hole 1381. For this reason, the lowest point of the overflow hole 1381 is preferably formed to be lower than the lowest point of the dehydrated sludge outlet 133. That is, the lowest point of the dehydrated sludge outlet 133 should be formed to be higher than the lowest point of the overflow hole 1381 so that water is first discharged through the overflow hole 1381. Preferably, the dehydrated sludge outlet 133 may be provided on an upper end side. In addition, the dehydrated sludge outlet 133 may be formed to be inclined upward in a discharge direction so that even when water moves toward the dehydrated sludge outlet 133, the inclined surface can prevent water from being discharged. With this configuration, it is possible to prevent the water derived from the diluted water and sludge introduced from the food waste treatment device from flowing into the second sludge treatment unit together with the dehydrated sludge through the dehydrated sludge outlet 133 as much as possible.

A plurality of perforations are formed in the perforated mesh case 136 so that the water derived from the diluted water and sludge introduced from the food waste treatment device may be discharged to the outside. In this case, when the perforations are clogged or a large amount of diluted water flows in temporarily, water may be discharged through the overflow hole 1381. The water discharged to the outside through the perforated mesh case 136 and the water discharged through the overflow hole 1381 may be discharged to the outside through the dehydration outlet 132 (see FIG. 3).

The shaft 135 operates as the center of rotation using a bearing portion 1395 or the like and includes a shaft body portion 1351 and a blade 1353. As shown in FIG. 13, the shaft body portion 1351 is provided in the inner space formed by the sludge treatment unit first case 137, the sludge treatment unit second case 138, and the perforated mesh case 136. The shaft body portion 1351 is formed to have a diameter that increases from the sludge inlet 131 toward the dehydrated sludge outlet 133, and the blade 1353 is formed in a spiral shape and operates to move the sludge toward the dehydrated sludge outlet 133 when rotating. That is, the shaft body portion 1351 and the blade 1353 are formed in a screw shape.

Sludge and dilution water (salt dilution water) discharged from the food waste treatment device 200 are input through the sludge inlet 131. The sludge is dehydrated inside the sludge treatment unit first case 137 and the sludge treatment unit second case 138.

The dehydrated sludge may be discharged to the stirring chamber of the second sludge treatment unit 150 through the dehydrated sludge outlet 133.

The support 139 may be fixed to external components to support a load of the sludge treatment unit 130.

Meanwhile, when water is discharged through the dehydrated sludge outlet 133, there is a problem that the drying efficiency of the sludge is reduced. The sludge treatment unit 130 according to the present embodiment can increase the drying efficiency of the sludge due to the above-described structural features.

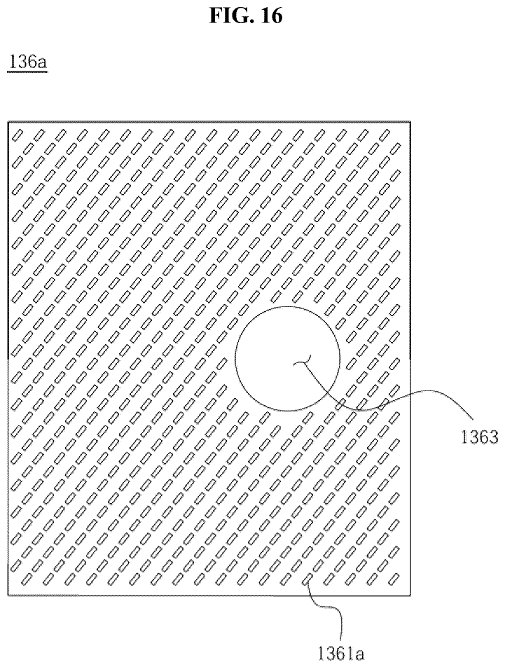

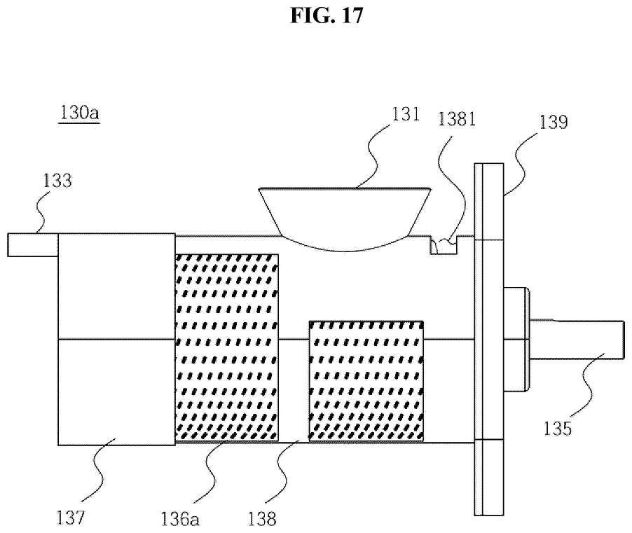

A sludge treatment unit according to another embodiment will be described with reference to FIGS. 16 and 17. FIG. 16 is an unfolded view showing the unfolded exterior of the perforated mesh case according to another embodiment, and FIG. 17 is a front view showing the exterior of a sludge treatment unit adopting the perforated mesh case of FIG. 16.

As shown in FIG. 16, the perforations formed in the perforated mesh case 136a may be formed as straight perforations 1361a. A diagonal or horizontally straight perforation 1361a may be formed in a portion excluding a through hole 1363 for a sludge inlet.

In this way, by forming the straight perforation 1361a in the perforated mesh case 136a, it is possible to improve drainage properties and enhance sludge mobility.

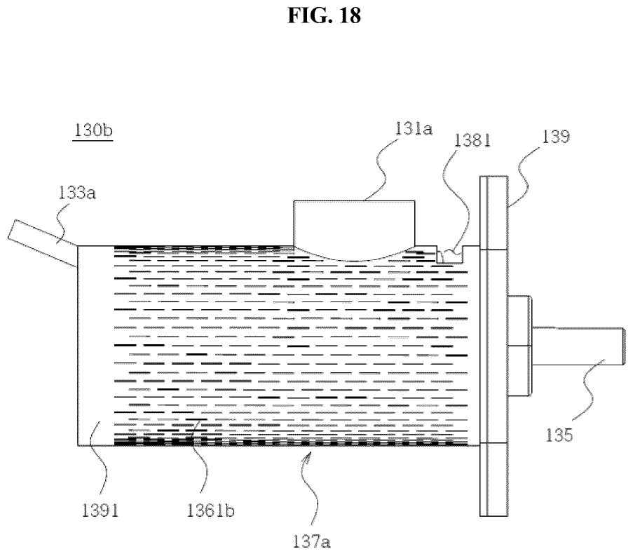

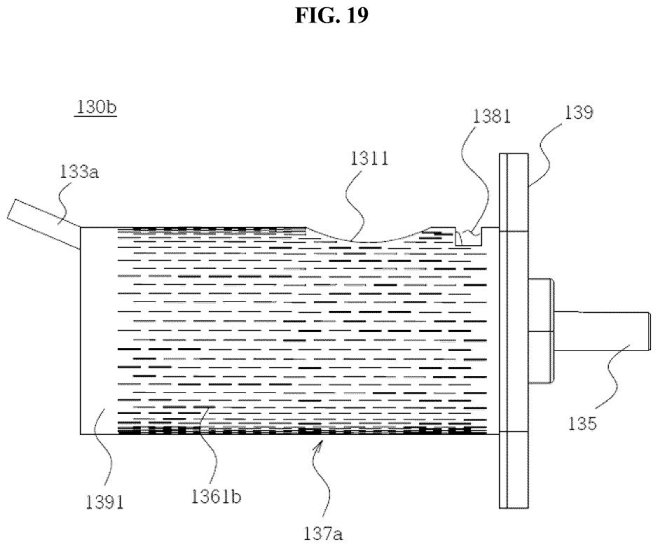

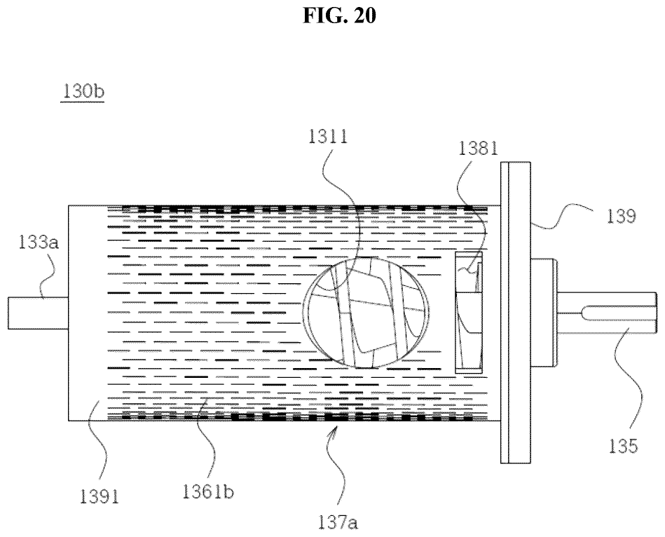

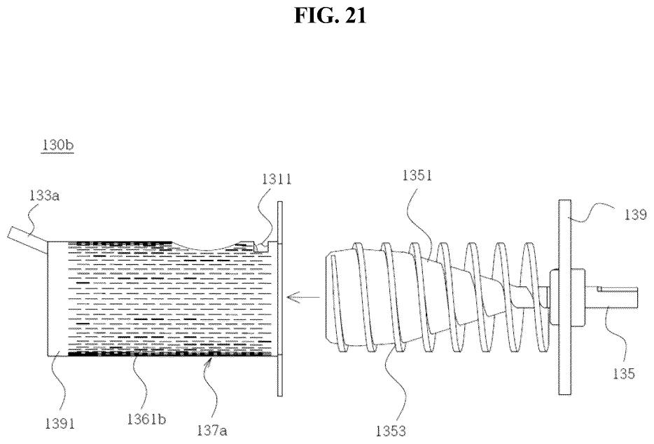

The sludge treatment unit according to another embodiment will be described with reference to FIGS. 18 to 21. FIGS. 18 and 19 are front views showing a sludge treatment unit according to other embodiments, FIG. 20 is a plan view showing the sludge treatment unit of FIG. 19, and FIG. 21 is an exploded view showing the sludge treatment unit of FIG. 19.

In the above-described embodiment, the perforated mesh case 136a (see FIG. 17) and the housings 137 and 138 (see FIG. 17) are formed in a double structure, but the sludge treatment unit 130b according to the present embodiment differs in structure from the above-described embodiments in that it is directly formed integrally with the housing 137a. That is, the housing 137a formed integrally with the perforated mesh case may be manufactured by forming a straight perforation 1361b in the housing without a perforated mesh case provided separately from the housing. With this structure, it is possible to reduce the number of manufacturing processes and reduce manufacturing costs.

The sludge treatment unit 130b according to the present embodiment may be formed so that the straight perforations 1361b are arranged in a straight shape in a longitudinal direction (moving direction of sludge) of the housing 137a. A circular perforated mesh has a problem of becoming easily clogged. On the other hand, since the straight perforation 1361b is formed long in the moving direction of sludge when formed in a straight shape, the perforated mesh is not easily clogged.

In addition, it is preferable that a perforation region in which the straight perforations 1361b are formed is not formed to an end of the housing at which the outlet 133a is located, and the straight perforations 1361b are not formed in a region within a predetermined distance from the end of the housing. Heat and pressure are generated by sludge being compressed inside a non-perforation region 1365 by the rotation of the shaft. The heat and pressure generated inside the non-perforation region may not only increase sludge drying, but also kill microorganisms that cause odors, thereby eliminating the cause of sludge odors.

In addition, the dehydrated sludge outlet 133a according to the present embodiment is formed to be inclined upward toward an end portion, thereby preventing water from being discharged through the sludge outlet.

The sludge treatment unit 130b according to the present embodiment may have a sludge inlet 131a formed in the form of a connection tube as shown in FIG. 18 or have a hole-shaped sludge input hole 1311 that communicates with the inside of the housing without a connection tube such as the sludge inlet 131a as shown in FIG. 19. That is, the sludge input hole 1311 with a hole shape passing through from the outside to the inside to receive sludge from a food treatment device may be formed in the housing. In addition, the sludge input hole 1311 may be connected to other tubes for inputting sludge.

The other components are similar to those of the above-described embodiments. For example, the shaft 135 operates as the center of rotation using the bearing portion 1395 or the like and includes the shaft body portion 1351 and the blade 1353. The shaft body portion 1351 is provided in an inner space of the housing 137a. The shaft body portion 1351 is formed to have a diameter that increases from the sludge input hole 1311 toward the dehydrated sludge outlet 133a, and the blade 1353 is formed in a spiral shape and operates to move the sludge toward the dehydrated sludge outlet 133a when rotating. That is, the shaft body portion 1351 and the blade 1353 are formed in a screw shape.

According to a sludge recycling device according to the present invention, it is possible to maintain the moisture content of sludge discharged from a food waste treatment device within an appropriate range and at the same time, prevent water from being discharged together with sludge in a sludge treatment process to the next process, thereby increasing sludge drying efficiency.

In addition, according to the present invention, sludge movement and drainage capacity can be improved by using a linearly perforated mesh case and a housing in an integrated form to increase the directionality of a screw upon rotation, and the heat and pressure generated inside a non-perforated region can not only increase a drying rate of the sludge, but also kill microorganisms causing odors, thereby eliminating the cause of sludge odors.

Although certain embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A sludge treatment unit provided in a sludge recycling device for recycling sludge discharged from a food waste treatment device and configured to treat the sludge introduced from the food waste treatment device, the sludge treatment unit comprising:
a housing having a plurality of perforations to discharge water from inside to outside thereof;
a sludge input hole provided in the housing to pass through from the outside to the inside of the housing to receive the sludge;
a dehydrated sludge outlet provided at a side different from the sludge input hole to discharge dehydrated sludge; and
a shaft having a shaft body portion provided inside the housing and a spiral blade provided on an outer circumferential surface of the shaft body portion, the shaft being rotated by a rotational force received from a motor to move the sludge from the sludge input hole toward the dehydrated sludge outlet.

2. The sludge treatment unit of claim 1, wherein each of the plurality of perforations is formed as a straight perforation with a rectangular shape.

3. The sludge treatment unit of claim 2, wherein a longitudinal direction of the perforation is formed and arranged parallel to a longitudinal direction of the housing.

4. The sludge treatment unit of claim 1, wherein the housing has a non-perforation region in which the plurality of perforations are not formed within a predetermined length from an end portion thereof at which the dehydrated sludge outlet is located.

5. The sludge treatment unit of claim 1, wherein the shaft body portion is formed to have a diameter that increases from the sludge input hole toward the dehydrated sludge outlet.

6. The sludge treatment unit of claim 1, wherein longitudinal directions of the plurality of perforations are formed and arranged to be diagonal based on vertical and horizontal directions.

7. The sludge treatment unit of claim 1, wherein the dehydrated sludge outlet is formed to be inclined upward toward an end portion thereof.

8. The sludge treatment unit of claim 1, wherein an overflow hole is formed in an upper portion of the housing to allow water to overflow from the inside of the housing.

9. The sludge treatment unit of claim 1, wherein a tube-shaped sludge inlet is connected to the sludge input hole.

10. A sludge recycling device for recycling sludge discharged from a food waste treatment device, the sludge recycling device comprising:
a first sludge treatment unit configured to treat the sludge introduced from the food waste treatment device;
a second sludge treatment unit configured to stir and dry sludge introduced from the first sludge treatment unit to discharge stirring results; and
a motor configured to provide power to the sludge treatment unit and the second sludge treatment unit,
wherein the first sludge treatment unit comprises:
a housing having a plurality of perforations to discharge water from inside to outside thereof;
a sludge input hole provided in the housing to pass through from the outside to the inside of the housing to receive the sludge;
a dehydrated sludge outlet provided at a side different to the sludge input hole to discharge dehydrated sludge; and
a shaft having a shaft body portion provided inside the housing and a spiral blade provided on an outer circumferential surface of the shaft body portion, the shaft being rotated by a rotational force received from the motor to move the sludge from the sludge input hole toward the dehydrated sludge outlet.

11. The sludge recycling device of claim 10, wherein each of the plurality of perforations is formed as a straight perforation with a rectangular shape.

12. The sludge recycling device of claim 11, wherein a longitudinal direction of the perforation is formed and arranged parallel to a longitudinal direction of the housing.

13. The sludge recycling device of claim 10, wherein the housing has a non-perforation region in which the plurality of perforations are not formed within a predetermined length from an end portion thereof at which the dehydrated sludge outlet is located.

14. The sludge recycling device of claim 10, wherein the shaft body portion is formed to have a diameter that increases from the sludge input hole toward the dehydrated sludge outlet.

15. The sludge recycling device of claim 10, wherein longitudinal directions of the plurality of perforations are formed and arranged to be diagonal based on vertical and horizontal directions.

16. The sludge recycling device of claim 10, wherein the dehydrated sludge outlet is formed to be inclined upward toward an end portion thereof.

17. The sludge recycling device of claim 10, wherein an overflow hole is formed in an upper portion of the housing to allow water to overflow from the inside of the housing.

18. The sludge recycling device of claim 10, wherein a tube-shaped sludge inlet is connected to the sludge input hole.
